(19) United States
(12) Patent Application Publication
(10) Pub. No.: US 2005/0235532 A1
(43) Pub. Date: Oct. 27, 2005

(54) Bottle identifier

(76) Inventors: Rolf Eberl, Kincardine (CA); Peter Eberl, Kincardine (CA)

Correspondence Address: SMART AND BIGGAR, 438 UNIVERSITY AVENUE, SUITE 1500 BOX 111, TORONTO, ON, M5G2K8, CA

(21) Appl. No.: 10/799,643

(22) Filed: Mar. 15, 2004

(51) Int. Cl. G09F 3/00

(52) U.S. Cl. 40/310

(57) ABSTRACT

A bottle identifier may be placed around the neck of a bottle so that the bottle may be readily visually distinguished from other bottles. The bottle identifier has a body with an opening into which extends one or more resilient tabs. The opening receives the neck of the bottle with the tabs deflecting to assist in retaining the identifier on the bottle. A number of identifiers may be provided which are visually distinguishable from each other. For example, the identifiers may be provided in a variety of colours. Thus, the identifiers may be used to readily visually distinguish bottles of a number of different consumers.

### BACKGROUND OF THE INVENTION

This invention relates to an identifier for a bottle, a bottle identifying system, an identifiable bottle, and a related method for identifying bottles.

Beverages are often consumed in bottles. Where beverages are consumed in a social setting, such as a bar, the bottles of many different consumers may be present. This leads to the possibility that a consumer may lose track of his or her bottle. In consequence, the consumer may either assume the bottle is lost, and thereby be inconvenienced, or mistakenly appropriate another's bottle as his or her own, and thereby compromise hygiene as well as inconvenience another. Furthermore, unfortunately, there is a risk of someone intentionally swapping a bottle for another with adulterated contents.

This invention seeks to ameliorate these problems.

### SUMMARY OF INVENTION

A bottle identifier may be placed around the neck of a bottle so that the bottle may be readily visually distinguished from other bottles. The bottle identifier has a body with an opening into which extends one or more resilient tabs. The opening receives the neck of the bottle with the tabs deflecting to assist in retaining the identifier on the bottle.

A number of identifiers may be provided which are visually distinguishable from each other. For example, the identifiers may be provided in a variety of colours. Thus, the identifiers may be used to readily visually distinguish bottles of a number of different consumers.

According to the present invention, there is provided an identifier for a bottle having a neck, comprising: a body having a through hole with at least one resilient tab extending into said through hole, said through hole sized to allow reception of the neck of the bottle with said at least one resilient tab deflecting in order to retain said body on said neck.

According to another aspect of the invention, there is provided an identifiable bottle comprising: a bottle having a neck; a bottle identifier having a body having a through hole with at least one resilient tab extending into said through hole, said through hole receiving the neck of the bottle with said at least one resilient tab deflected so as to assist in retaining said body on said neck.

According to a further aspect of the present invention, there is provided a method of identifying bottles, comprising: placing a disk having a through hole with at least one resilient tab extending into said through hole around a neck of a bottle such that said at least one resilient tab deflects.

According to another aspect of the invention, there is provided a bottle identifying system comprising: a plurality of bottle identifiers, each bottle identifier having a through hole with at least one resilient tab extending into said through hole, said through hole sized to allow reception of a neck of a bottle with said at least one resilient tab deflecting in order to retain said bottle identifier on said neck; at least some of said plurality of bottle identifiers visually distinct from others of said plurality of identifiers.

Other features and advantages will become apparent from a review of the following description in conjunction with the drawings.

### BRIEF DESCRIPTION OF DRAWINGS

In the figures which illustrate example embodiments of the invention,

FIG. 1 is a front view of a bottle with a bottle identifier made in accordance with this invention,

FIG. 2 is a plan view of the bottle identifier of FIG. 1,

FIG. 3 is a perspective view of a bottle identifier made in accordance with another embodiment of this invention, and

FIG. 4 is a perspective view of a bottle identifier made in accordance with a further embodiment of this invention.

### DETAILED DESCRIPTION

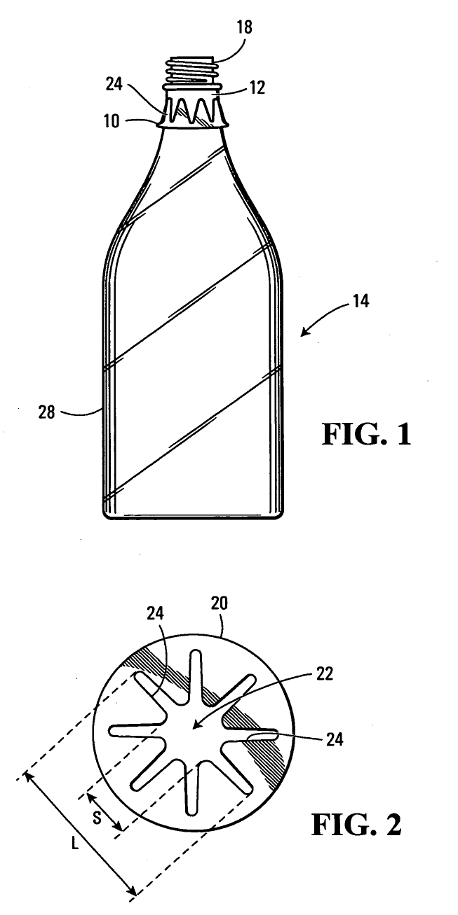

With reference to FIG. 1, a bottle identifier 10 may be placed around the neck 12 of a bottle 14. As best seen in FIG. 2, the bottle identifier has a body 20 with a through hole 22. A plurality of resilient tabs 24 may be symmetrically disposed about the hole 22. The tabs may be integrally formed with the body: the body and integral tabs, when the tabs are relaxed, may be in the nature of a (plate-like) disk.

The hole 22 of identifier 10 has a maximum diameter, L, which is greater than the diameter of the bottle cap engaging portion 18 of neck 12, but smaller than the diameter of the base 28 of the bottle 14. The tabs 24, being directed inwardly, leave a central opening with a diameter, S, which is smaller than that of the neck of the bottle. As illustrated, the bottle cap engaging portion 18 of neck 12 is a threaded portion of the neck, however, engaging portion 18 may also be, for example, a lip.

The bottle identifier may be made of plastic, cardboard, or other resilient material. The identifiers may be coloured with a wide variety of colorants: an identifier may be coloured uniformly or with a pattern of colours. Where the identifier is made of plastic, the plastic may be luminescent. Further, indicia may be printed on the identifiers. The identifiers may also be textured, such as by embossing.

In use, the hole 22 of the identifier 10 is registered with the neck 12 of the bottle 14 and the identifier is pressed over the neck, past the bottle cap engaging portion 18 of the neck. In doing so, the resilient tabs 24 deflect upwardly, as illustrated in FIG. 1. With the identifier in place on the bottle, the deflected resilient tabs assist in retaining the identifier on the neck of the bottle. Indeed, any attempt to slide the identifier off the neck is made difficult by the fact that the resilient tabs will jam against the bottle cap engaging portion 18 of the neck. In consequence, it will normally be necessary to destroy the identifier in order to remove it from the bottle. This assists in avoiding the possibility of an identifier being transferred to another bottle by a mal-intentioned individual.

It will be apparent that with a plurality of visually distinct identifiers 10, the identifiers may be used to distinguish the bottles of different consumers.

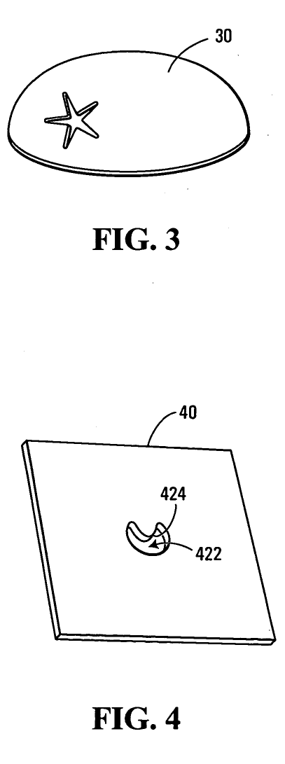

Rather than, or in addition to, the identifiers having different colours, the identifiers may have different shapes. Thus, for example, one or more identifiers in a package of identifiers may be elliptical in shape, as illustrated by the plate-like identifier 30 of FIG. 3. Or one or more identifiers may be square in shape, as illustrated by the plate-like identifier 40 of FIG. 4.

Identifier 40 also differs from identifier 10 (FIG. 1) and 30 (FIG. 3) in that it has a single resilient tab 424 extending into its hole 422.

It will be apparent that other modifications in shape and numbers of resilient tabs are possible.

Although each of the identifiers has been described as a plate-like element, the identifiers could be more three-dimensional. However, plate-like identifiers have the advantage that they are easily carried, such as in a change purse.

Other modifications will be apparent to those skilled in the art and, therefore, the invention is defined in the claims.

1. An identifier for a bottle having a neck, comprising:
a body having a through hole with at least one resilient tab extending into said through hole, said through hole sized to allow reception of the neck of the bottle with said at least one resilient tab deflecting in order to retain said body on said neck.

2. The identifier of claim 1 wherein said at least one tab comprises a plurality of tabs disposed about said hole.

3. The identifier of claim 2 wherein said tabs are symmetrically disposed about said hole.

4. The identifier of claim 3 wherein said body said tabs are integrally formed with said body.

5. The identifier of claim 1 wherein said hole has a maximum diameter smaller than a diameter of a base of said bottle.

6. The identifier of claim 4 wherein said body is a plate-like element.

7. The identifier of claim 1 wherein said body is fabricated of a luminescent material.

8. The identifier of claim 6 wherein said body is fabricated of plastic.

9. The identifier of claim 6 wherein said body is fabricated of cardboard.

10. An identifiable bottle comprising:
a bottle having a neck;
a bottle identifier having a body having a through hole with at least one resilient tab extending into said through hole, said through hole receiving the neck of the bottle with said at least one resilient tab deflected so as to assist in retaining said body on said neck.

11. The bottle of claim 10 wherein said at least one tab comprises a plurality of tabs disposed about said hole.

12. The bottle of claim 11 wherein said tabs are symmetrically disposed about said hole.

13. The bottle of claim 12 wherein said tabs are integrally formed with said body.

14. The bottle of claim 10 wherein said hole has a maximum diameter smaller than a diameter of a base of said bottle.

15. The bottle of claim 14 wherein said body is fabricated of plastic.

16. A method of identifying bottles, comprising:
placing a plate-like element having a through hole with at least one resilient tab extending into said through hole around a neck of a bottle such that said at least one resilient tab deflects.

17. A bottle identifying system comprising:
a plurality of bottle identifiers, each bottle identifier having a through hole with at least one resilient tab extending into said through hole, said through hole sized to allow reception of a neck of a bottle with said at least one resilient tab deflecting in order to retain said bottle identifier on said neck;
at least some of said plurality of bottle identifiers visually distinct from others of said plurality of identifiers.

18. The system of claim 17 wherein said at least some of said plurality of identifiers have a different colour than said others of said plurality of identifiers.
